(19) United States
(12) Patent Application Publication
(10) Pub. No.: US 2008/0196382 A1
(43) Pub. Date: Aug. 21, 2008

(54) METHOD AND APPARATUS FOR FORMING JEWELRY CHAINS FORMED FROM LINKS

(76) Inventor: David ROZENVASSER, Englewood Cliffs, NJ (US)

Correspondence Address: KATTEN MUCHIN ROSENMAN LLP, 575 MADISON AVENUE, NEW YORK, NY, 10022-2585, US

(21) Appl. No.: 12/033,070

(22) Filed: Feb. 19, 2008

Related U.S. Application Data
(60) Provisional application No. 60/902,318, filed on Feb. 20, 2007.

(51) Int. Cl. B21L 3/00; F16G 13/00; B23P 19/00; A44C 5/02

(52) U.S. Cl. 59/35.1; 59/78; 29/700; 63/4

(57) ABSTRACT

A method and apparatus for reducing the amount of metal used in a chain as compared to a chain formed of a round wire, the method including the steps of forming a wire having a non-round shape, wrapping the wire around a mandrel to form a spiral of the wire, the mandrel formed such that it supports the non-round shape of the wire with a longer dimension of the wire extending radially from an axis of the mandrel, cutting the spiral of wire to form individual links of wire, and forming a chain from said links.

### BACKGROUND OF THE INVENTION

1. Field of the Invention

The present invention relates to jewelry chains and more particularly to jewelry chains formed with multiple links interconnected together.

2. Discussion of the Prior Art

Many types of jewelry chains are formed by the interconnection of links. Initially the links are formed, typically with a gap within the periphery, and the links are then interconnected together to form a chain. Such chains can then be utilized as necklaces, bracelets, or parts of other types of jewelry.

One such typical chain is the well know rope chain. With rope chains, the links are interconnected in groups and the groups are held in place to form a double helix configuration. However, numerous other types of chains are well known which are formed by interconnecting links and securing these links together. Such chains can be, for example, the Prima Donna chain, the Forsetina chain, Curb chain, Karo chain, Byzentine chain, Rollo chain, Snapper chain or Russian chain.

In order to form such chains, initially a link must be formed. Numerous methods are available for forming the link. In one method, the link is stamped out of a sheet of precious material. The links are then grouped together and interconnected to form the particular type of jewelry chain.

In other processes, the link is formed of a wire which is bent to form the particular shape of the link. The wire is typically fed from a spool.

Historically, links were manufactured by hand and thereafter, the individual formed links were assembled by hand to form the particular chain configuration. However, machines have been provided to form the links. Furthermore, machines have also been provided, at least for some types of chains, to interconnect or interweave the links together to form a particular chain configuration. Some machines will only form the links and thereafter, the links can be either assembled by hand or provided as loose links to other machines where the links are then interconnected together. Other types of machines will simply take the loose links and weave then or interconnect them to form the chain. Yet further machines will provide both the formation of the link, as well as provide for the assembling and interconnecting of the links to form the actual chain.

The type of wire that is used can be either solid or hollow. However, typically, the wire is one that has a round cross section. There have occasionally been chains formed with links where the link is formed of wires other than round cross section. Such links were typically made by hand. Utilizing non-round cross sectional wire in machine manufactured links has been rare, if at all possible. With a round cross sectional wire, orientation of the wire is not an issue since no matter what the radial orientation is of the wire, it will always be round.

Attempts have been made to use non-round cross sectional wire to form links using machines. However, these have been rare and generally laid the wire with its broader flat side against a post around which the wire was bent, in order to maintain stability and orientation of the wire as it was being formed into the link.

### SUMMARY OF THE INVENTION

The present invention appreciates that by using non-round cross sectional wire, and orienting the wire with its longer cross sectional direction lying along a radius of the link, one can achieve the same overall outer dimension of a similar chain that would be made of wire with a round cross sectional area, but at a considerable reduction of the amount of precious material forming the chain. This will result in a substantial cost savings. Furthermore, the present invention provides for a method and apparatus for achieving such formation of links by machine processes, especially utilizing a process where the wire in wound around a mandrel.

The invention also provides for jewelry chains formed of links wherein the links are machine manufactured using non-round cross sectional wire, with the longer dimension of the cross section of the wire lying along the radial direction of the link. In this manner, the overall appearance of the resulting chain will have a substantially same outer dimension as if the wire would have a round cross section, but with substantially less precious material being utilized to form the chain.

An embodiment of the invention also provides for a machine which forms links by using non-round cross sectional wire and winding the wire around a mandrel with the orientation of the wire such that its longer cross sectional direction lies along the radius of the link. In another embodiment, it also includes assembling such links on a machine to form a particular type of chain.

### BRIEF DESCRIPTION OF THE DRAWINGS

FIGS. 1A, 1B, 1C and 1D show various chains formed from links;

FIG. 2 shows a typically annular link;

FIGS. 3A, 3B and 3C show cross sections of the wire used to form a link;

FIG. 4 shows a different shaped link;

FIGS. 5A-5E schematically show various steps in accordance with one method for machine manufacture of links from wire;

FIGS. 6A-6C schematically show various steps in accordance with a second method for machine manufacture of links from wire;

FIGS. 7A-7D shown various types of wires utilized for making links with the wires having different cross sections;

FIGS. 8A and 8B show various views in the formation of a link in accordance with the first method of machine manufacture of chains;

FIGS. 9A and 9B are views similar to that of FIGS. 8A and 8B but showing use of a different cross section of wire forming the link;

FIG. 10 is another embodiment of machine formation of a link using the first method and with yet a different cross section wire;

FIG. 11 is a cross section showing wire wound around a mandrel in accordance with the second method of machine manufacture;

FIGS. 12A-12I show various cross section of wires that can be used with the present invention;

FIGS. 13 is a view similar to FIG. 11 and showing yet a further cross section wire wound around a mandrel in accordance with the present invention;

FIG. 14 is a schematic showing the feeding of the wire through a machine to form a chain, in accordance with the present invention; and

FIG. 15 is a schematic showing a particular type of a retaining apparatus as shown in FIG. 14.

### DESCRIPTION OF THE PREFERRED EMBODIMENTS

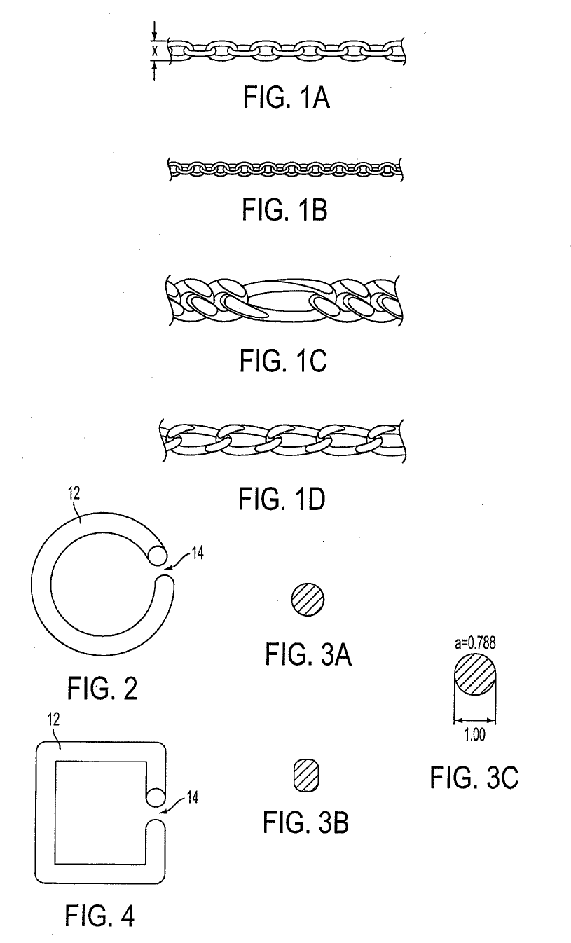

Many types of jewelry chains are formed by taking links and intertwining or assembling them in a particular pattern in order to form a chain. FIGS. 1A-1D show various types of well known chains which are formed by interconnecting multiples of different links together. Many other types of chains utilize links that are interconnected. The overall outside dimension of the chain is shown in FIG. 1A by the dimension X, measured from the outer lateral edges of the chain. This dimension is typically determined by the overall outer dimension of the individual links that are utilized to form the chain.

By way of example, FIG. 2 shows a typically annular link that is utilized in the formation of such a chain. However, other configurations and shapes of links are well known. By way of example, FIG. 4 shows a substantially square configuration of the link. Typically the links are formed by an outer periphery of material 12 and having a gap 14 there between. The outer periphery is usually formed of precious metal such as gold, silver, platinum, or combinations thereof.

Three types of machines are known for forming links. In one type, the links are formed by punching the shape of the link out of a sheet of material. Other ways of forming of the links is to start with a wire. In one type of machine, wrap the wire around a post. In another type it is wound around a mandrel. The shape of the post as well as the shape of the mandrel does not have to be round. Other types of peripheral shapes of the post and mandrels are well known. In the case of a round post or mandrel, the link will have a round configuration as in FIG. 2. Using other shapes, such as a square, a link configuration as shown in FIG. 4 would result. However, many other shapes are well known using such posts and/or mandrels.

When starting with wire, the link typically has a wire of a circular cross section as shown in FIG. 3A. Typically after the wire is wound around a mandrel or post to form the link, and the gap is formed, the link that is formed may not be lying in a flat plane. The link may therefore be hammered or pressed downward to lie on a straight plane. In doing so, the sides of the link may be somewhat flattened so that the shape of the cross section of the wire is flattened, as shown in FIG. 3B. Additionally, after the links have been formed from round wire, they may also be reshaped by faceting or shaving the periphery of the link. However, all these reshaping are subsequent to the formation of the link, wherein the link starts out with a round cross sectional wire.

Referring to FIG. 3C, it is seen that using a round cross sectional wire of about 1 mm diameter, the area cross section will be 0.788 mm². The significance of the area is that it will determine the amount of precious metal needed to form the link, and thus the weight of the precious metal, such as gold, involved in the formation of the chain.

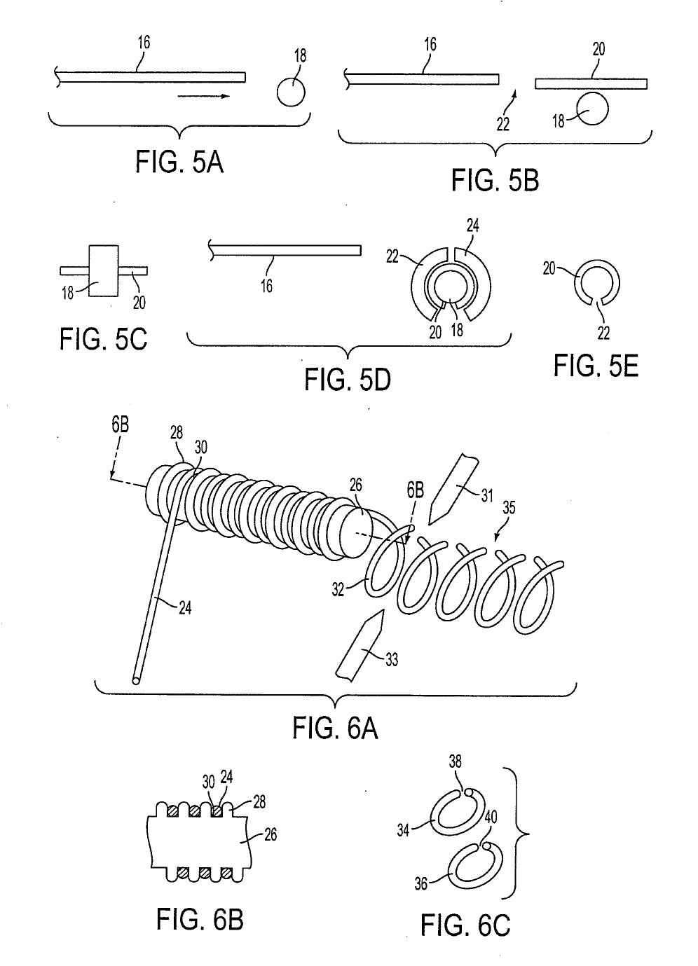

The two methods of making links from wire by machine processes will be described in more detail. The first method is shown in FIGS. 5A-5E. In FIG. 5A, it schematically shows a wire 16 which is fed, typically from a spool, toward the machine in which there is provided a post 18.

As shown in FIGS. 5B and 5C, the wire is fed to the machine until a portion 20 spans across the post 18. The wire is then cut at a point 22. As shown in FIG. 5D, a pair of arms 22, 24, or other anvil or press, bends the cut wire 20 around the post 18. As shown in 5E, the resulting link is a piece of wire 20 annularly bent with a gap 22 formed in the center.

While this method is available, the more prevalent method of machine made links is shown in FIGS. 6A-6C. In this case, a wire 24 again typically fed from a spool, is fed toward the machine. In the machine there is provided a mandrel 26 with a periphery having upstanding walls 28, forming a groove 30 there between. Effectively, the upstanding walls 28 can be considered as a spring wound around the mandrel.

The wire 24 is fed to the mandrel and wound around the mandrel in the grooves 30 between the spring walls 28. The wire thereby forms a spiral 32 around the mandrel which is pulled off at the end of the mandrel 26. As the spiral is pulled off the mandrel, a pair of blades 31, 33 are generally provided on either side for cutting the spiral whereby individual links 35 are shown. FIG. 6B shows a cross section of the mandrel 26 having the spring walls 28 with the wire 24 lying in the grooves in a spiral fashion around the mandrel.

After the spiral 32 is pulled off the mandrel, the individual links which are cut from the spiral are shown in FIGS. 6C as the links 34 and 36. These links have respective gaps 38, 40. If necessary, the links can then be flattened to place them in a planar orientation, or can be assembled in the offset position and straightened out as they are intertwined with the next link.

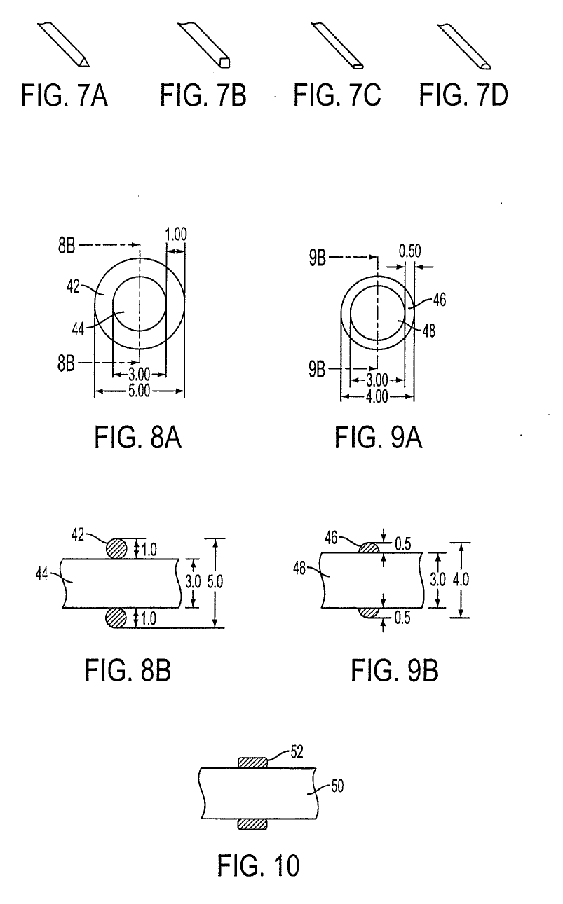

Although in most cases, round cross section of wire is used to form the links, it has been suggested to use other cross sectional shape of wires. By way of example, in FIGS. 7A-7D, there are shown shapes other than round cross sectional wire, which has been used to form chains.

In using non-round wire to form links by using machine processes, numerous problems are faced. One problem is to maintain the proper orientation of the wire as it is fed to the machine. With round wire, of course, there are no orientation problem since the wire is universally symmetrical around its periphery. However, with the types of non-round cross sectional shaped wire shown in FIGS. 7A-7D, orientation of the wire as it is fed to the machine is significant.

An additional problem is the stability of the wire as it is being manufactured during the machine processing steps. Where such shapes such as FIGS. 7A-7D have been utilized in machine manufacture, the shapes have typically been placed so that the larger diameter, or flattened surface is against the post or mandrel during the bending or winding process around the post or mandrel. This provides the greatest stability of the wire during its manufacturing process on the machine as it is being formed and bent into a link.

However, the problem that is then faced is that the resulting chain that will be formed utilizing these links, will either weigh more than using round cross sectional wire, or if it weighs less, the size of the chain will be smaller than a corresponding chain using round cross sectional wire.

This can best be demonstrated in FIGS. 8, 9 and 1O. By way of example, FIGS. 8A and 8B shows a link 42 being bent around a mandrel or post 44. The thickness of the post or mandrel, by way of example, is shown as 3 mm, the thickness of the circular wire is 1 mm. As a result, the overall outer dimension of the link will be 5 mm.

Referring back to FIG. 1A, using a link having an outer diameter of 5 mm, and forming the chain of 1A, the outer dimension X, shown in Fig. A will correspond to the 5 mm size of the link. Thus, the chain in FIG. 1A would be considered a 5 mm chain.

Refer now to FIGS. 9A and 9B, it is shown where the wire cross section of 7D is being utilized. Specifically, this is a semicircular shaped cross sectional wire. In this case, the width of the wire is still 1 mm. However, the height of the wire as shown in FIG. 7D would be 0.5 mm.

As shown in FIG. 9A, by taking such a wire 46 and winding it around a post or mandrel 48, if again the mandrel is 3 mm, since the wire is laid with its flat portion against the post or mandrel 48, the overall outer dimension of the link will be 4 mm. While in this case, half of the weight of the wire will be utilized, and therefore half the amount of gold, the overall dimension of the chain of FIG. 1A will be a 4 mm chain, rather than a 5 mm chain.

FIG. 10 likewise shows the use of the wire shown in FIG. 7C which is wound around a mandrel or post 50 with the wire 52 lying flat around the mandrel or post. Although in this case, the wire is thinner than a round cross sectional wire, again because it is placed flat around the mandrel or post, the overall outer dimension of the link will be substantially less than that of a corresponding circular cross sectional wire. The resulting chain will likewise be substantially smaller.

The major reason for placing the wire in the direction as heretofore shown, is to maintain the stability of the wire as it is being bent around the post or mandrel. The orientation of the wire must be maintained as it is fed to the mandrel or post and must be also retained as it is bent or shaped into the link shape. For this reason, the flattened or wider side of the wire has historically been utilized for such purpose. Accordingly, to achieve a chain having the same outer diameter of a corresponding chain made with round cross sectional wire, there has been no savings in the amount of gold utilized.

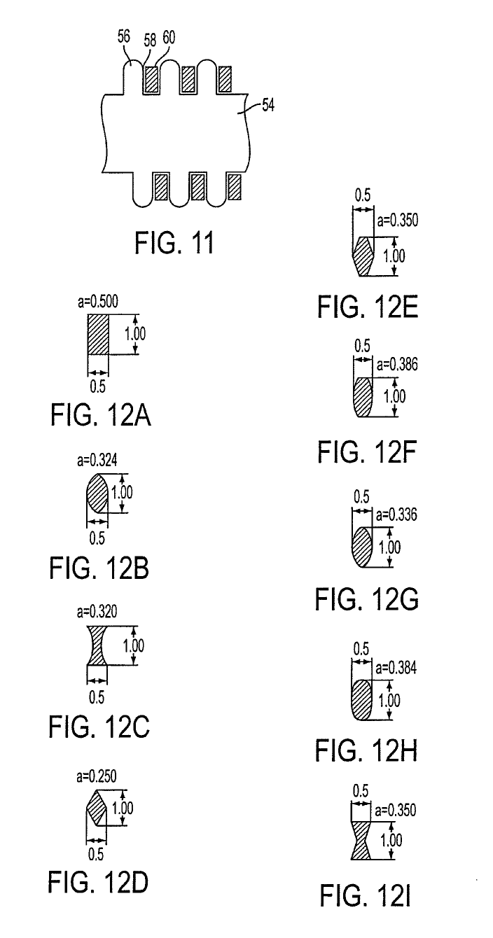

FIG. 11 shows a mandrel 54, having spring fingers 56, forming grooves 58 there between, where a rectangular shaped cross sectional wire 60 is placed between the fingers. In this case, the elongated direction of the wire has been placed so that the longer dimension of the wire is radialy positioned with respect to the diameter of the mandrel 54.

Placing the wire around the mandrel in the direction shown in FIG. 11 will provide some weight saving. If the height of the wire as shown in the radial direction is 1 mm and if the thickness of the wire in the transverse direction is less than a millimeter, there will be some weight savings to produce a chain of the same corresponding outer diameter as if a round cross sectional wire were utilized.

However, the problem in utilizing wire and placing it in the elongated direction as shown in FIG. 11 is not only the orientation problem but also a stability problem. Heretofore, it has not been possible to achieve great weight savings by placing the wires in the direction as shown in FIG. 11 using machine made links.

The present invention proposes, on the other hand, substantial weight savings, at least greater than 15% and even greater than 20%, by utilizing cross sectional shapes of wires having a cross sectional area at least 20% and greater less than the cross sectional area of a corresponding round cross sectional wire. However, the outer shape of the chain produced by such links will have the same outer dimension as that of a chain utilizing a cross sectional wire.

Referring to FIG. 3C, it will again be noted that using a 1 mm cross sectional round wire, the resulting surface area of the wire is 0.788 mm². In order to achieve a weight savings of 15% or more, the cross sectional surface area of the wire used to produce the links should be less than 0.669 mm². For at least a 20% savings, it should be less than 0.630 mm². However, in order to achieve the same outer dimension of the chain, the height in the elongated direction, which will be the direction in which the wire is radialy placed around the mandrel, must be the same as the diameter of the round wire, namely 1 mm.

Shown in FIGS. 12A-12I are various possible cross sectional wires that can be utilized for this purpose. By way of example, in FIG. 12A, there is shown a rectangular cross sectional wire. The height of course is 1 mm. In this case, however, the width is 0.5 mm and the resulting surface area is 0.509 mm². This will be about a 35% savings in the weight of precious material.

In FIG. 12B there is shown a cross sectional shape in the form of a pointed oval, similar to a football shape. Again, the height is 1 mm, the width is 0.5 mm and the resulting area is 0.324 mm². In this case a 58% savings in weight of precious material.

FIG. 12C shows an hour class cross section with again a height of 1 mm and a width at its maximum of 0.5 mm and a resulting area of 0.32 mm². In this case, it will be a weight saving of 59%.

Of the various figures, FIG. 12D, which shows a Rhombus, again having a height of 1 mm and a width at its maximum of 0.5 and a resulting area of 0.250 mm². In this case the weight savings will be about 68%.

Likewise the various shapes 12E-12I are shown with the cross sectional area of the shape, all of which will produce a weight savings of greater than 15% with respect to the corresponding shape of a circular cross sectional wire as shown in FIG. 3C. Nevertheless, each of these, because the height is 1 mm, and that wire will be wound around the mandrel with that 1 mm being in the radial direction of the diameter of the mandrel, the corresponding link shape will be the same outer diameter as if a round wire was used, and correspondingly the overall chain that will result will likewise have the outer diameter the same as that of a round wire.

It should be appreciated that the wires shown in FIGS. 12A-I are all by way of examples. Any cross shaped wire meeting the criteria of the invention could likewise be used.

It should be appreciated, that the particular unique shape of the resulting link occurs as a result of the initial wire that is being utilized and not as a result of any flattening, reshaping, faceting or changing of the shape. Heretofore, where round wire was used, different shapes could be achieved by reshaping. However, such did not achieve a savings in the weight and accordingly would not achieve savings in the amount of precious material being utilized.

One of the reasons why such wires have not been utilized heretofore, could be the lack of appreciation of the weight savings resulting from the use of such wire. A second reason may have been the inability to accommodate the orientation and stability of utilizing such wire in machine processing of the links. By way of example the Rhombus cross sectional wire shown in FIG. 12D, which of those figures shown, has the greatest weight savings, could produce difficulties in trying to wind such wire around a mandrel. The wire shape does not have a broad base upon which stability against the bottom of the mandrel can be achieved. Also it requires accurate orientation and direction to maintain the wire being fed to the mandrel. All of these may have presented the inability to recognize the benefits that can be achieved from utilizing such cross sectional wires.

Applicant has been able to achieve use of such cross sectional wires based upon its recognition of the great weight savings that can result by utilizing such cross sectional shapes. At the same time, the weight savings do not affect the overall outer diameter of the link, and therefore the overall diameter of the chain. In this situation, applicant can achieve chains with the same outer diameter as that of a round cross sectional wire with savings of greater than 15% of the amount of precious metal used.

The major requirement is that when the wire is fed from a spool, or other source, to the mandrel for forming the spiral, appropriate orientation and alignment apparatus is required. By way of example, in FIG. 14 there is shown a schematic of a type of apparatus that could be used. Specifically, during the feeding operation from the spool to the mandrel it is necessary to maintain an accurate orientation of the wire as it is being fed between the spring walls around the periphery of the mandrel. This can be done by various orientation means. It can be a direct path along which the wire is fed; it can be an aperture opening upon entry into the mandrel corresponding to the shape of a wire; it could be a shaped groove along which the bottom portion of the wire rides in as it traverses the path, or at least upon entry to the mandrel, or any other orientation type of means.

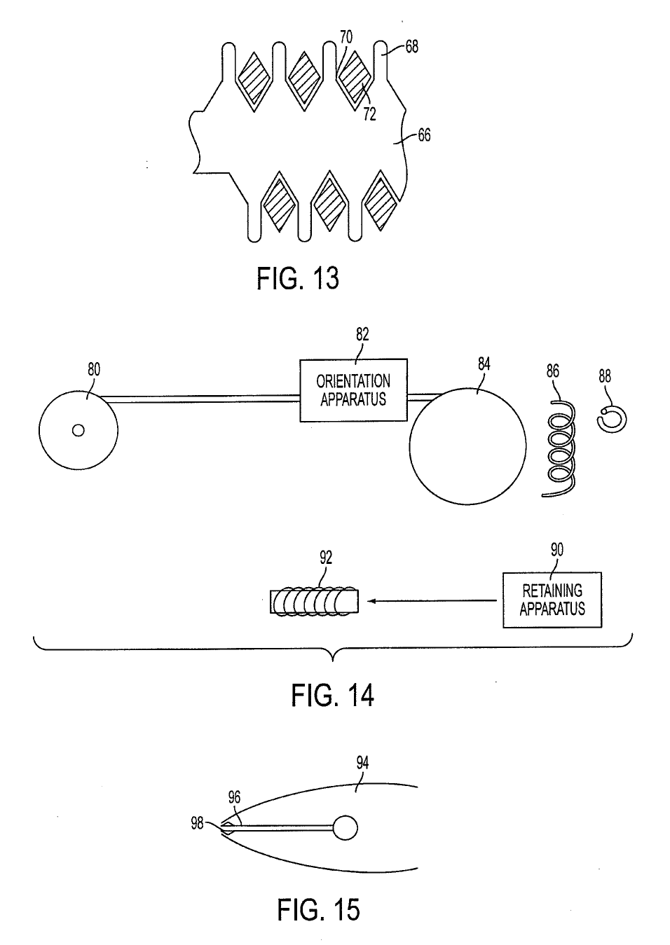

Additionally, another possibility is as shown in FIG. 13. In this case the mandrel 66 is shown with the spring fingers 68. However, the base portion 70 between the spring fingers is shaped into a V shape to correspond with the bottom shape of the cross section of the wire 72. Such grooves can be either formed directly between the fingers in the mandrel, it could be by means of an insert placed between the fingers or it could be shaped along the inner surface of the spring fingers, or other ways.

It should be appreciated, however, that any other type of method could be utilized to maintain the orientation of the shape of the wire as it is fed along to the mandrel to accommodate such cross sectional shapes as heretofore described.

Referring again back to FIG. 14, the resulting wire spiral 86 emitted from the mandrel is then cut into links 88. Again the cross sectional shape of the link 88 would be the cross section of the wire and can be any of those shown in FIGS. 12A to 12I or others producing a savings of at least 15% of the weight.

Once the links 88 are formed, because of the different cross sectional configurations, it may be necessary to again orient these links through a retaining or orienting apparatus 90 as they are fed into the machine for forming the actual chain 92. By way of example, FIG. 15 shows a type of tweezers or pincers 94, having a groove 96 which receives the links. The cut out 98 at the front end would be shaped according to the cross sectional shape of the wire being utilized. In that way, the pincers will hold the link even with its non-round shape. These pincers are then used to intertwine one link with another. In this way it will orient the link in the proper direction as it is being interconnected to adjacent links.

There are numerous types of machines that collect individual links and produce any of the chains shown in FIGS. 1A-1B, or the numerous other types of chains well known and using links. In addition to making use of machines, the unique links of the present invention could also be assembled by hand to make such chains.

Although the heretofore description of the present invention dealt with solid cross sectional shapes, it should be appreciated that the same benefit would occur using hollow wire. Furthermore, any type of link configuration could be used whether its circular or square as heretofore shown or any other well known shape of link. Furthermore, any type of chain using links can be utilized without limitation as long as it requires a link.

### Features

Accordingly, one of the features of the present invention is to provide chains formed of links, with the link providing the same outer diameter of the chain as would a corresponding link formed of a round cross sectional wire, but utilizing a non-round cross sectional wire having a cross sectional shape other than round and resulting in at least a 15% savings in precious metal.

Another feature of the present invention is the ability to provide a machine made link, by winding a wire around a mandrel having spring like fingers on its exterior, wherein the wire cross section is other than round, and being wound such that the longer dimension of the wire is radialy positioned with respect to the diameter of the mandrel. The longer dimension corresponds to the diameter of a round wire that would have been utilized, and the width of the wire in its narrow dimension being such that the cross section shape of the wire being utilized produces a savings of at least 15% in precious metal as compared to the corresponding equivalent chain using round cross sectional wire.

Another feature of the present invention is a method of machine manufacture of links using cross sectional wire other than round cross sectional wire, wherein the longer dimension of cross sectional area of the wire is fed around a mandrel while maintaining its orientation around the mandrel. The longer dimension is radialy maintained about the periphery of the mandrel as it is wound around the mandrel. The width or narrow dimension of the cross sectional area of the wire is such that the cross sectional area produces at least a 15% savings in the weight of the resulting chain that will be formed, as compared to having used round cross sectional area wire.

I claim:

1. A method of reducing the amount of metal used in a chain as compared to a chain formed of a round wire, the method comprising the steps of:
forming a wire having a non-round shape;
wrapping the wire around a mandrel to form a spiral of the wire, said mandrel formed such that it supports the non-round shape of the wire with a longer dimension of the wire extending radially from an axis of the mandrel;
cutting the spiral of wire to form individual links of wire; and
forming a chain from said links.

2. The method of claim 1, wherein the non-round shape is a polygon.

3. The method of claim 1, wherein the non-round shape is an oval.

4. The method of claim 1, wherein the non-round shape includes at least one arcuate surface.

5. The method of claim 1, wherein the non-round surface includes at least one convex surface.

6. The method of claim 1, wherein the non-round surface includes at least one concave surface.

7. The method of claim 1, wherein the chain has the same overall outer dimension of a similar chain that made of wire with a round cross sectional area.

8. A machine for forming a jewelry chain from a non-round wire comprising:
a mandrel including a plurality of spring fingers spaced apart from one another with grooves formed there between;
a means of supplying a non-round wire to said mandrel;
means for wrapping the non-round wire about the mandrel to form a spiral of non-round wire; and
means for cutting the spiral of non-round wire a predetermined intervals to form links of non-round wire.

9. The machine of claim 8, wherein the spring fingers are formed such that the grooves between the spring fingers have substantially the same shape as the non-round wire.

10. The machine of claim 8, wherein a base portion of the mandrel is formed such that the grooves between the spring fingers have substantially the same shape as the non-round wire.

11. The machine of claim 8, further comprising an orientation means, wherein the orientation means maintains proper orientation of the non-round wire as it is supplied to the mandrel.

12. The machine of claim 8, further comprising an orientation means for said formed links of non-round wire.

13. The machine of claim 8, further comprising means of forming the links into a chain.

14. A jewelry chain formed of a non-round wire, said chain comprising:
a plurality of links formed on a non-round wire, said links having a long dimension lying along the radial dimension of the link, wherein said links are formed by wrapping the wire around a mandrel to form a spiral of the wire, said mandrel formed such that it supports the non-round shape of the wire with a longer dimension of the wire extending radially from an axis of the mandrel.
